(19) United States
(12) Patent Application Publication
(10) Pub. No.: US 2022/0234005 A1
(43) Pub. Date: Jul. 28, 2022

(54) ENTRANCE FEATURES IN SPIRAL WOUND ELEMENTS

(71) Applicant: Aqua Membranes, Inc., Albuquerque, NM (US)

(72) Inventors: Rodney Herrington, Albuquerque, NM (US); Kevin Roderick, Albuquerque, NM (US); Craig Beckman, Albuquerque, NM (US)

(21) Appl. No.: 17/610,499

(22) PCT Filed: May 1, 2020
(86) PCT No.: PCT/US20/30915

§ 371 Date: Nov. 11, 2021

Related U.S. Application Data
(60) Provisional application No. 62/849,952, filed on May 19, 2019.

(51) Int. Cl. B01D 63/10; B01D 69/12; B32B 3/26; B32B 7/12; B32B 5/02; B32B 7/05

(52) U.S. Cl. CPC B01D 63/103; B01D 69/12; B32B 3/263; B01D 2313/143; B32B 5/028; B32B 7/05; B32B 7/12

(57) ABSTRACT

Features applied to the inlet or exit edges of membrane sheets in spiral wound membrane elements may incorporate different heights or patterns than the feed space patterns in the middle of the membrane sheets in order to facilitate more open and more fluid dynamically favorable inlet spaces for the feed solution in spiral wound membrane elements. This configuration can reduce the fouling potential on the feed end of the membrane element, and provide less pressure drop on the inlet and exit ends of the membrane modules.

### TECHNICAL FIELD

The subject invention relates to membrane systems utilized for the separation of fluid components, specifically spiral-wound membrane elements.

### BACKGROUND ART

Spiral-wound membrane filtration elements are known in the art, and typically consist of a laminated structure comprised of a membrane sheet sealed to or around a porous permeate carrier which creates a path for removal, longitudinally to the axis of the center tube, of the fluid passing through the membrane to a central tube, while this laminated structure is wrapped spirally around the central tube and spaced from itself with a porous feed spacer to allow axial flow of the fluid through the element. Traditionally, a feed spacer is used to allow flow of the feed water, some portion of which will pass through the membrane, into the spiral wound element and allow reject water to exit the element in a direction parallel to the center tube and axial to the element construction.

Improvements to the design of spiral wound elements have been disclosed in U.S. Pat. No. 6,632,357 to Barger et al., U.S. Pat. No. 7,311,831 to Bradford et al., and patents in Australia (2014223490) and Japan (6499089) entitled “Improved Spiral Wound Element Construction” to Herrington et al., which replace the conventional feed spacer with islands or protrusions either deposited or embossed directly onto the inside or outside surface of the membrane. Typically, fluid feed flow is normal to the center tube of the spiral wound element. In fabrication, after winding the element in the spiral configuration, the membrane sheet envelope is cut off after gluing and the feed edge of the membrane envelope presents a flat surface to the flow of feed solution. US patent application PCT/US17/62425 entitled “Flow Directing Devices for Spiral Sound Elements” to Herrington, et al., describe anti-telescoping devices that incorporate turning vanes to cause fluid flow to sweep the feed end of the spiral wound element to help avoid blockage of particles in the feed stream from impinging on the end of the membrane envelope. None of these patents describe features that can be applied to the membrane sheet envelope on the inlet (also called the feed or entrance) and exit (also called the reject or outlet) end of the envelope of the spiral wound element that improve the flow path into the feed end of the element or from the reject end of the element.

### DISCLOSURE OF INVENTION

Understanding of the present invention can be facilitated by the context of U.S. Pat. No. 6,632,357 to Barger et al., U.S. Pat. No. 7,311,831 to Bradford et al., and patents in Australia (2014223490) and Japan (6499089) entitled “Improved Spiral Wound Element Construction” to Herrington et al., each of which is incorporated herein by reference.

Embodiments of the present invention provide tapered ends on the membrane envelope to create a more aerodynamic or hydrodynamic entrance path into the feed spaces in a spiral wound membrane element, as well as a smoother transition from the element on the reject end of the element. The modified ends can be achieved by, as examples, combining (a) a narrow permeate carrier with bonding of the edges of the membrane envelope directly to one another with (b) a modified feed spacer in these regions to provide substantially uniform layer thickness. This configuration can be difficult to incorporate in conventional feed spacer mesh that has a uniform flat configuration. However, by employing feed spacers that are printed directly on the membrane surface tapered features can be integrated in the feed spacer print pattern on the feed and reject ends of the membrane sheet to facilitate more hydrodynamic entrance and exit flow paths.

### BRIEF DESCRIPTION OF DRAWINGS

FIG. 1 is a schematic illustration of a conventional spiral wound membrane element prior to rolling.

FIG. 2 is an end view of a spiral wound membrane element.

FIG. 3 is a cross section view of a conventional mesh-type membrane element.

FIG. 4 is a section view of an example embodiment showing an inlet end of a spiral wound membrane element with feed spacers that force the end of the membrane envelope to taper to a close.

FIG. 5 is a section view of an example embodiment showing the inlet end of a spiral wound membrane element after the ends of the membrane envelope have been trimmed off.

FIG. 6 is a section view of an example embodiment showing an inlet end of a spiral wound membrane element after the ends of the membrane envelope have been trimmed off such that taller spacers at the inlet and exit end are maintained in place.

FIG. 7 is a section view of an example embodiment having an entrance end of a spiral wound membrane element with adhesive only applied to the membrane sheets.

FIG. 8 is a section view of an example embodiment having the entrance end of a spiral wound membrane element with the permeate carrier tapered on the edges.

FIG. 9 is a section view of the edge of an example embodiment comprising a membrane element which incorporates conventional feed spacer mesh.

### MODES FOR CARRYING OUT THE INVENTION AND INDUSTRIAL APPLICABILITY

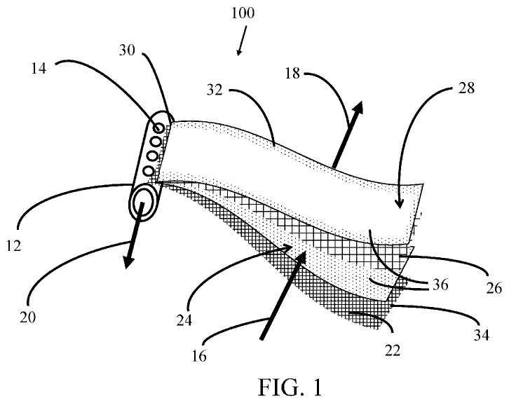

FIG. 1 is a schematic illustration of a conventional spiral wound membrane element prior to rolling, showing important elements of a conventional spiral wound membrane element 100. Permeate collection tube 12 has holes 14 in collection tube 12 where permeate fluid is collected from permeate carrier 22. In fabrication, membrane sheet 36 is a single continuous sheet that is folded at center line 30, comprised of a non-active porous support layer on one face 28, for example polysulfone, and an active polymer membrane layer on the other face 24 bonded or cast on to the support layer. In the assembled element, active polymer membrane surface 24 is adjacent to feed spacer mesh 26, and non-active support layer 28 is adjacent to permeate carrier 22. Feed solution 16 enters between active polymer membrane surfaces 24 and flows through the open spaces in feed spacer mesh 26. As feed solution 16 flows through feed spacer mesh 26, particles, ions, or chemical species, which are excluded by the membrane are rejected at active polymer membrane surfaces 24, and molecules of permeate fluid, for instance water molecules, pass through active polymer membrane surfaces 24 and enter porous permeate carrier 22. As feed solution 16 passes along active polymer membrane surface 24, the concentration of materials excluded by the membrane increases due to the loss of permeate fluid in bulk feed solution 16, and this concentrated fluid exits the reject end of active polymer membrane sheet 24 as reject solution 18. Permeate fluid in permeate carrier 22 flows from distal end 34 of permeate carrier 22 in the direction of center tube 12 where the permeate fluid enters center tube 12 through center tube entrance holes 14 and exits center tube 12 as permeate solution 20. To avoid contamination of the permeate fluid with feed solution 16, non-active polymer membrane layers 28 are sealed with adhesive along adhesive line 32 through permeate carrier 22 thereby creating a sealed membrane envelope where the only exit path for permeate solution 20 is through center tube 12. Typically, the width of the adhesive line 32 is 1-3″ after the adhesive has been compressed during the rolling process.

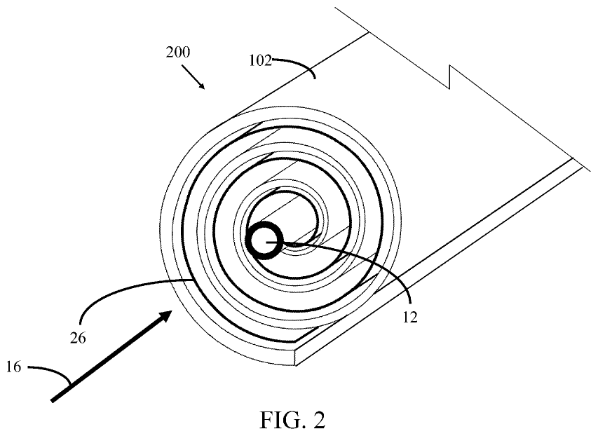

An assembled spiral wound membrane element 200 is shown in FIG. 2. A membrane envelope 102 comprises, as described in connection with FIG. 1, a membrane sheet 36 folded at one end with a permeate carrier 22 disposed therebetween the membrane sheet and sealed along the edges with a suitable adhesive. In the conventional design of membrane element, a feed spacer mesh 26 is placed adjacent to envelope 102 to allow the flow of feed fluid 16 to flow between membrane envelope 102 and expose all of the active polymer surfaces of the membrane sheet to feed fluid. Permeate, or product fluid is collected in the permeate carrier inside membrane envelope 102 and proceeds spirally down to center tube 12 where the product, or permeate fluid is collected. A single spiral wound element may comprise a single membrane envelope and feed spacer layer, or may comprise multiple membrane envelopes and feed spacer layers stacked and rolled together to form the element.

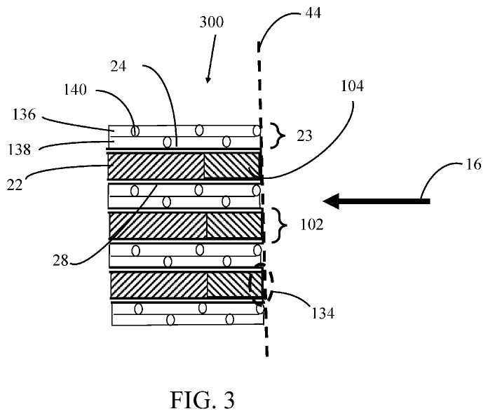

Referring to FIG. 3, a membrane envelope is created by sealing edges of a first 24 membrane sheet, a layer of permeate carrier 22, and a second 28 membrane sheet together with an adhesive 104. In the process of fabrication of a spiral wound element, the individual membrane leaves 24 and 28 are folded in half and permeate carrier 22 is placed between each folded sheet and the adhesive is applied on top of the permeate carrier and the element is rolled to produce the layered spiral configuration. During the rolling process, adhesive 104 must penetrate through permeate carrier 22 in order to properly seal membrane sheets 24 and 28 together to create membrane envelope 102 as in FIG. 2. To complete final construction of membrane element, the ends are trimmed through adhesive material 104 along cut line 44. After trimming, the adhesive line 32 at the edges of the element typically extends 1-2″ inward into the permeate carrier from the face 134 of the membrane envelope 102. In many fluid feed applications, fluid 16 may contain particles or impurities that may impinge on the flat end faces 134 of envelope 102 thereby allowing particles to collect on the end faces 134 thereby restricting fluid flow into the feed spaces between the leaves of envelope 102. In addition, feed spacer mesh 23 can typically comprise a plastic webbing type mesh whereby the cut ends of the mesh will also act to accumulate particles in the entrance area of feed spaces between envelope 102. Feed spacer mesh 23 comprises upper strands 136 and lower strands 138 that are bonded together at contact points 140. Another undesirable characteristic of the existing mesh type spacer membrane elements is that feed fluid has to flow over and under strands 136 and 138 which creates pressure losses in the mesh spacer. These pressure losses increase the energy costs of operation of membrane systems. If pressure losses can be decreased, the overall energy requirements for the system can be reduced. In typical construction of a conventional membrane element 200, membrane sheets 24 and 28 enclose permeate carrier 22 extending to the edge of the membrane sheets that allows the flow of permeate to the center collection tube 12 (FIG. 2).

From a fluid dynamic standpoint, feed fluid 16 impinging on flat end faces 134 of membrane envelop 102 is not optimal, and creates additional resistance to fluid flow as the fluid transitions from bulk flow into the feed channels.

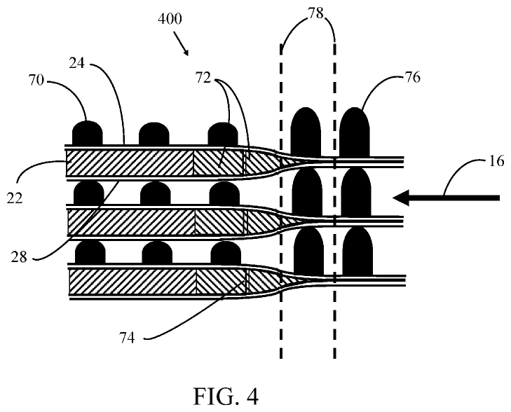

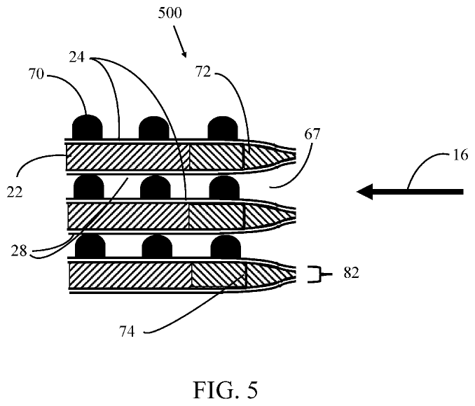

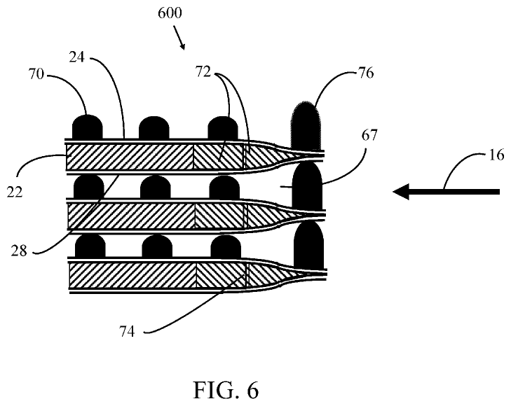

In an example embodiment of the present invention shown in FIG. 4, a cross section of a portion of the end of the membrane module 400 is shown. Feed spacer mesh 23 (FIG. 3) is replaced with spacing features 70 having a first thickness applied directly to one active polymer surface of membrane leaf 24. Spacing features 70 can be any pattern or height compatible with the desired performance of the system. The opposing side of membrane leaf 28 can optionally have spacing features applied to the surface. In the example embodiment shown, permeate carrier 22 is not extended all the way to the end of membrane sheets 24 and 28, and is terminated at edge 74 of permeate carrier 22. In this embodiment the edge of the permeate carrier 74 still extends within the width of the adhesive line 72. To facilitate sealing of membrane sheets 24 and 28 together during element manufacture without the presence of the permeate carrier between the membrane sheets, spacing features 76 of a second thickness, greater than the first thickness, are applied at the end edges of membrane sheet 24, extending approximately to the edge of the permeate carrier 74. As membrane element is rolled together during fabrication, thicker spacing features 76 cause membrane sheets 24 and 28 to squeeze together at the ends thereby bringing membrane sheets 24 and 28 in contact at the end edges. Adhesive 72 seals the ends of membrane sheets 24 and 28 and also the permeate carrier 22 to seal the membrane envelope and separate it from the feed and reject fluid flow. After the adhesive has cured, the end of membrane element can be trimmed off, e.g., at one of cut lines 78 producing the configurations shown in FIG. 5 and FIG. 6.

The thicker spacing features 76 can be uniform in thickness, or can vary in thickness from thicker toward the edge away from the permeate carrier to thinner towards the permeate carrier so as to create a thickness transition from the outer edge to the area of the permeate carrier. The thickness of thinner spacer 70 and thicker spacers 76 are selected such that the thicker spacer is, at its maximum thickness, equal to or nearly equal to the thickness of permeate carrier 22 that is present between the inner portions of the sheets but not present near the edge. This allows the overall thickness of each complete layer of the element, including membrane sheets 24 and 28, permeate carrier 22, thinner and thicker spacers 70 and 76, and adhesive 72, to be effectively constant so that element rolls to a substantially uniform diameter throughout.

A cross-sectional portion of the element end 500 as in FIG. 5 in the example embodiment provides a smooth and tapered inlet channel for feed fluid 16 to enter feed space 67 between membrane sheets 24 and 28 after the excess edge and feed spacer have been trimmed. For example, permeate spacer 22 can be 0.010 inches in height. Membrane sheets 24 and 28 can be, for example, 0.005 inches in height. In the example embodiment shown in FIG. 5, end face 82 of the membrane envelope can be, for example, 0.010 inches tall in contrast to the thicker end face 134 shown in FIG. 3. Thinner end face 82 can be advantageous because it provides less frontal surface area to collect particles which can restrict flow of feed fluid 16. Thinner end face 82 also allows a tapered inlet channel to fluid feed space 67 which can be advantageous in reducing pressure losses in the inlet of the feed channel, thereby reducing the energy required to pump fluid through the element.

Trimming the element such that thicker end feed spacers 76 (FIG. 4) are removed can provide an open configuration for flow. As described in FIG. 5, however, it is difficult to roll and trim a spiral wound element with precision to ensure that design. The configuration shown in FIG. 6 shows another embodiment of the cross section of the edge of membrane element 600 that retains the thicker end feed spacers 76 by trimming the end further from permeate carrier 22. In this example, some of thicker end feed spacers are trimmed off while some 76 remain in the feed channel. These features provide more of an obstruction to the feed channel than the configuration shown in FIG. 5, but still provide more open area for flow than can be achieved if feed spacer 70 were uniform in height from one end of the element to another.

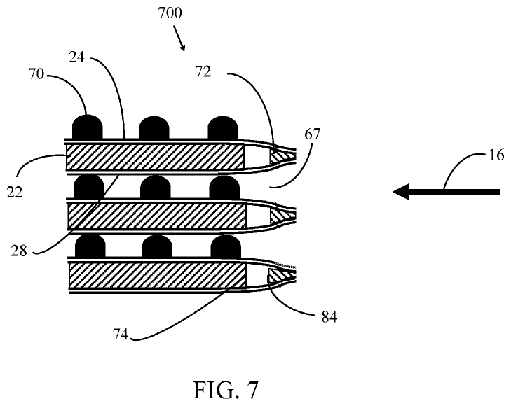

Referring to FIG. 7, cross section of the edge of a membrane element 700 shows an example embodiment in which less adhesive is used to seal the membrane envelope. The amount of adhesive required to seal the membrane leaf can be reduced significantly by applying adhesive 72 such that only tapered cavity 84 (FIG. 5) at the edge of the membrane envelope contains adhesive after trimming; adhesive does not need to extend inward to the outer edge 74 of permeate carrier 22. This can be accomplished by employing a narrower permeate carrier 22 which does not extend as far towards the edges of the element, by reducing the amount of adhesive 72 used to create the adhesive line 32, or a combination of the two. In conventional membrane element fabrication, glue must penetrate permeate carrier 22 and come in contact with the back sides of membrane sheets 24 and 28. This fabrication approach is often challenging for the characteristics of adhesive 72. Adhesive 72 in the conventional fabrication approach must have very specific viscosity, thixotropy, and wetting properties in order to penetrate permeate carrier 22 and seal the back side of the membrane sheet. When adhesive 72 is only required to seal the two back sides of membrane leaves 24 and 28, as in the example embodiment of FIG. 7, the characteristics of adhesive 72 can be much less specific, which can result in lower cost materials as well lower volume of adhesive. Utilizing only enough adhesive to seal membrane sheets 24 and 28 minimizes the amount of adhesive required. The present invention will function both with and without the adhesive layer extending into the outer edge of permeate carrier 74.

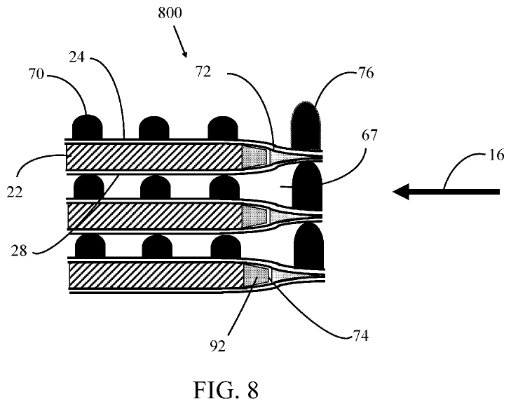

In an example embodiment shown in FIG. 8, the cross section of the edge of membrane element 800 contains a modified permeate carrier edge. The outside edges of porous permeate carrier 92 are thinner relative to portions distal from such edges to better facilitate the transition area between thinner 70 and thicker 76 feed spacers. In embodiments where permeate carrier 22 comprises a woven or extruded thermopolymer material, the thinning can be done by heating the edge under pressure, using a heat sealer, for example. Having the edge of permeate carrier 22 taper or step down reduces the severity of flexing or deformation required by membrane sheets 24 and 28 as it is compressed during rolling. Other example methods of creating a thinner outer edge of permeate carrier 92 include custom pressing, extrusion, custom weaving, co-molding of a tapered edge onto an existing sheet of permeate carrier, and combinations thereof.

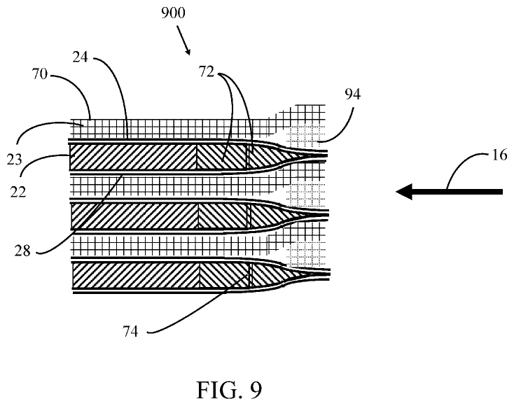

While the previous examples have all incorporated feed spacers printed directly on the membrane surface, which can provide the benefit in the areas of reduced pressure loss through the element and reduced end fouling, similar stepped- or tapered-end configurations can also be produced using conventional feed spacer mesh and a permeate carrier layer that does not extend across the entire length of the membrane element. An example embodiment depicted in FIG. 9 shows the cross section of the edge of a membrane element 900 which incorporates conventional feed spacer mesh. A single continuous feed spacer of one thickness 23 provides the feed spacing between membrane sheets 24 and 28 while additional mesh strips 94, the same thickness as the permeate carrier, are disposed at each edge of the feed spacer to create a uniform thickness during element rolling. While such an example embodiment might not provide all of the advantages of the printed embodiments, a stepped mesh spacer can still provide improvements in pressure loss as compared to conventional elements rolled with a single thickness feed spacer.

Similarly, a combination of mesh and printed elements can be employed to provide stepped or graded entrance/exit features provided that they are configured such that the combined spacers at the edges create an opening for the feed to reject flow while adding thickness to make up for the area at the edge where the permeate carrier is not present.

Filtration membrane, particularly thin-film composite reverse osmosis membrane, is typically very fragile, and can be damaged by contact with feed spacer mesh or by the process of printing or depositing features onto the film surface. Accordingly, it can be advantageous to enable assembly of an element where there is no printed or mesh feed spacer contacting the active surface of the membrane sheets. Australian patent 2014223490 describes printing features on the permeate carrier, which in turn deform or emboss the membrane sheet in order to provide feed spacing, but it is difficult to provide feed spacing separation at the edges adjacent to the adhesive in such a configuration. By combining thinner feed spacers disposed on the permeate carrier with thicker spacers at the edges disposed on the membrane surface, an element can be created without any printed or mesh spacing features in contact with the active surface of the membrane, while providing additional spacing at the ends of the element. The areas of the membrane sheet that are in contact with the thicker spacer are sealed to one another with adhesive, preventing permeation through the membrane in these areas. Therefore, any damage to the surface of the membrane sheet caused by the thicker edge spacers will not affect the permeation or salt rejection characteristics of the membrane sheet.

Although the primary hydrodynamic and fouling improvements occur when this technique is applied to the edge seals of the membrane envelope, it can be seen that the techniques described can also be applied to the adhesive seal at the distal edge 34 of the membrane envelope which will still benefit from reduced adhesive and permeate carrier usage. In the case of the end seal, the addition of a thicker feed spacer can be used, but it is not as necessary as keeping the thickness constant across the end seal which can also be achieved by having no spacer features across the end of the leaves.

The present invention has been described in connection with various example embodiments. It will be understood that the above description is merely illustrative of the applications of the principles of the present invention, the scope of which is to be determined by the claims viewed in light of the specification. Other variants and modifications of the invention will be apparent to those skilled in the art.

1. A laminated composition for use in fluid filtration, comprising:
(a) a first permeable membrane sheet portion having an active surface and a second surface opposite the active surface;
(b) a second permeable membrane sheet portion having an active surface and a second surface opposite the active surface;
(c) a permeate carrier disposed between the first and second permeable membrane sheets, with the second surface of each sheet facing the permeate carrier, wherein the permeate carrier has an edge thickness in an edge region corresponding to a region near an edge of the first permeable membrane sheet and an inner thickness in an inner region corresponding to a region inwards from the edge region, where the edge thickness is greater than the inner thickness.

2. The laminated composition of claim 1, further a comprising a feed spacer, wherein the feed spacer is disposed facing the active surface of the first permeable membrane sheet, and wherein the feed spacer has an edge thickness in edge region and an inner thickness in a region not near the edge, wherein the difference between the edge and inner thicknesses of the feed spacer element is the same as the difference between the inner and edge thicknesses of the permeate carrier.

3. The laminated composition of claim 2, wherein the feed spacer comprises a sheet of mesh material having an additional layer of mesh material disposed in the edge region.

4. The laminated composition of claim 3, wherein the thickness of the additional layer of mesh material is equal to the difference between the inner and edge thicknesses of the permeate spacer element.

5. The laminated composition of claim 1, wherein the edge thickness of the permeate carrier is zero.

6. The laminated composition of claim 1, wherein the permeate carrier comprises a plurality of spacing elements disposed on the second surface of the first permeable membrane sheet, the second surface of the second permeable membrane sheet, or a combination thereof; wherein the spacing elements disposed in the edge region have a thickness less than the thickness of the spacing elements in the inner region.

7. The laminated composition of claim 2, wherein the feed spacer comprises a plurality of spacing elements disposed on the active surface of the first permeable membrane sheet, the active surface of the second permeable membrane sheet, or a combination thereof, wherein the spacing elements disposed in the edge region have a thickness greater than the thickness of the spacing elements in the inner region.

8. The laminated composition of claim 1, wherein the permeate carrier thickness tapers smoothly from the first thickness to the second thickness.

9. The laminated composition of claim 1, further comprising adhesive disposed between the first and second permeable membrane sheets in the edge region and not in the inner region.

10. A method of making a spiral wound water processing element, comprising:
(a) providing a laminated composition as in claim 1;
(b) disposing adhesive between the first and second permeable membrane sheets in the edge region;
(c) rolling the laminated spiral composition into a spiral element;
(d) removing a portion of the spiral element corresponding to a portion of the edge region.
